(19) United States
(12) Patent Application Publication
(10) Pub. No.: US 2006/0227241 A1
(43) Pub. Date: Oct. 12, 2006

(54) Apparatus and method for adjusting colors of an image

(76) Inventors: Phil Van Dyke, Surrey (CA); Barinder Singh Rai, Surrey (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 11/099,952

(22) Filed: Apr. 6, 2005

(51) Int. Cl. H04N 11/04

(52) U.S. Cl. 348/384.1

(57) ABSTRACT

A hardware implemented method for adjusting colors of an image is provided. In this method, lookup table (LUT) values stored in an LUT are copied to a memory to create a copy of the LUT values, whereby the LUT values define the original colors of the image. Subsequently, the LUT values stored in the LUT are modified to change the colors of the image. To restore the image to its original colors, the LUT values stored in the LUT that were modified are overwritten with the copy of the LUT values stored in the memory. A graphics controller and an LUT for adjusting colors of an image also are described.

### BACKGROUND

1. Field of the Invention

This invention relates generally to computer graphics and, more particularly, to method and apparatus for adjusting colors of an image.

2. Description of the Related Art

The colors of an image displayed on a display panel can be manipulated to blank the image. That is, the image can be blanked by changing all colors to black or white. The image is typically blanked to provide transitions between one image to a next image or is blanked to conserve power. Graphics controllers used in small, portable devices typically implement the blanking effect by driving all liquid crystal display (LCD) interface signals to either all high or low, thereby changing the image to a complete white or black color, respectively. Specifically, to implement the blanking effect, a display panel interface within the graphics controller is programmed to ignore all output signals from a lookup table and/or from a frame buffer, and is simply programmed to set all data signals outputted to display panel to all high or low.

The problem with setting the data signals to all high or low is that a gradual fading or brightening effect can not be implemented. In other words, since the image is instantaneously blanked to all black or white, the graphics controller can not drive the colors of the image to gradually fade or brighten to black or white, respectively, over a period of time. An external central processing unit (CPU) that feeds pixel information to the graphics controller may be programmed to gradually change the colors of the image to provide the fading or brightening effect, but such processing can consume large CPU bandwidths which slows the processing of other tasks handled by the CPU.

In view of the foregoing, there is a need to provide method and apparatus to adjust the colors of the image, which can create a blanking or fading effect, that utilizes minimal CPU bandwidth.

### SUMMARY

Broadly speaking, the present invention fills these needs by providing hardware implemented method and apparatus for adjusting colors of an image. It should be appreciated that the present invention can be implemented in numerous ways, including as a method, a system, or a device. Several inventive embodiments of the present invention are described below.

In accordance with a first aspect of the present invention, a hardware implemented method for adjusting colors of an image is provided. In this method, lookup table (LUT) values stored in an LUT are copied to a memory to create a copy of the LUT values, whereby the LUT values define the original colors of the image. Subsequently, the LUT values stored in the LUT are modified to change the colors of the image. To restore the image to its original colors, the LUT values stored in the LUT that were modified are overwritten with the copy of the LUT values stored in the memory.

In accordance with a second aspect of the present invention, an LUT for adjusting colors of an image is provided. The LUT includes circuitry for copying LUT values stored in the LUT to a memory to create two copies of the LUT values. The LUT values define the original colors of the image, and the first copy of the LUT values is stored in the LUT and the second copy of the LUT values is stored in the memory. LUT additionally includes circuitry for modifying the LUT values stored in the LUT to change the colors of the image, and includes circuitry for overwriting the modified, LUT values stored in the LUT with the LUT values stored in the memory to restore the image to its original colors.

In accordance with a third aspect of the present invention, a graphics controller for adjusting colors of an image is provided. The graphics controller includes a host interface and a graphics controller memory in communication with the host interface. Additionally included is an LUT in communication with the host interface and the graphics controller memory. The LUT includes circuitry for copying LUT values stored in the LUT to the graphics controller memory to create two copies of the LUT values. The LUT values define the original colors of the image, and the first copy of the LUT values is stored in the LUT and the second copy of the LUT values is stored in the graphics controller memory. The LUT additionally includes circuitry for modifying the LUT values stored in the LUT to gradually converge at a final color value over a time period, and includes circuitry for overwriting the modified, LUT values stored in the LUT with the LUT values stored in the graphics controller memory to restore the image to the original colors.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a simplified schematic diagram of an apparatus for adjusting colors of an image, in accordance with one embodiment of the present invention.

FIG. 2 is a detailed schematic diagram of the graphics controller shown in FIG. 1, in accordance with one embodiment of the present invention.

FIG. 3 is a flowchart diagram of a high level method overview for adjusting colors of an image, in accordance with one embodiment of the present invention.

FIGS. 4A, 4B, and 4C are simplified block diagrams of exemplary operations for adjusting the colors of an image, in accordance with one embodiment of the present invention.

FIG. 5 is a flowchart diagram of a method for adjusting colors of an image such that the colors fade or brighten over a time period, in accordance with one embodiment of the present invention.

### DETAILED DESCRIPTION

An invention is described for hardware implemented method and apparatus for adjusting colors of an image. It will be obvious, however, to one skilled in the art, that the present invention may be practiced without some or all of these specific details. In other instances, well known process operations have not been described in detail in order not to unnecessarily obscure the present invention.

The embodiments described herein provide graphics controller and hardware implemented method for adjusting colors of an image. In one embodiment, lookup table (LUT) values stored in the LUT of a graphics controller are copied to an unused portion of a memory. As will be explained in more detail below, the LUT values basically control the color of the image. Accordingly, the original colors of the image can be changed by modifying the LUT values stored in the LUT. The ability to change the colors by modifying the LUT values allows the image to be blanked, faded, or brightened. To restore the image to its original colors, the modified, LUT values can be overwritten with the copy of original LUT values stored in memory.

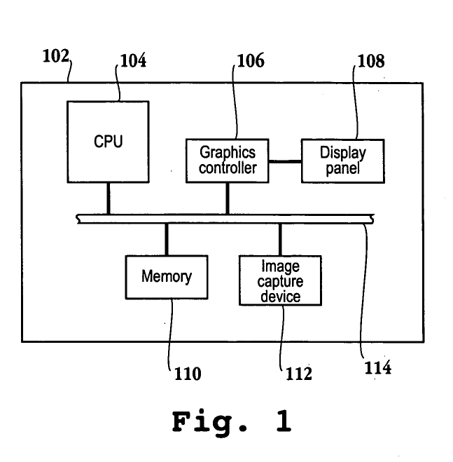

FIG. 1 is a simplified schematic diagram of an apparatus for adjusting colors of an image, in accordance with one embodiment of the present invention. Apparatus 102 includes any suitable type of computing device. For example, apparatus 102 may be a personal digital assistant, a cell phone, a web tablet, a pocket personal computer, a portable electronic computing device, etc. As shown in FIG. 1, apparatus 102 includes central processing unit (CPU) 104, memory 110, graphics controller 106, display panel 108, and image capture device 112. Graphics controller 106 is in communication with CPU 104, memory 110, display panel 108, and image capture device 112. One skilled in the art will appreciate that CPU 104, memory 110, graphics controller 106, and image capture device 112 may be in communication through common bus 114.

Memory 110 includes any suitable memory types, such as static access memory (SRAM), dynamic random access memory (DRAM), etc. Display panel 108 may include random access memory (RAM) integrated display panels, liquid crystal displays (LCD), thin-film transistor (TFT) displays, cathode ray tube (CRT) monitors, televisions, etc. Apparatus 102 may additionally include image capture device 112 that records photographic images as image data and outputs the raw image data to graphics controller 106. For example, image capture device 112 may include a charge-coupled device (CCD) to capture the image. The CCD is a light-sensitive integrated circuit that stores and displays data for an image in such a way that each pixel in the image is converted into an electrical charge the intensity of which is related to a monochrome color. Of course, a complementary metal-oxide semiconductor (CMOS) chip, a widely used type of semiconductor, may be additionally utilized instead of a CCD.

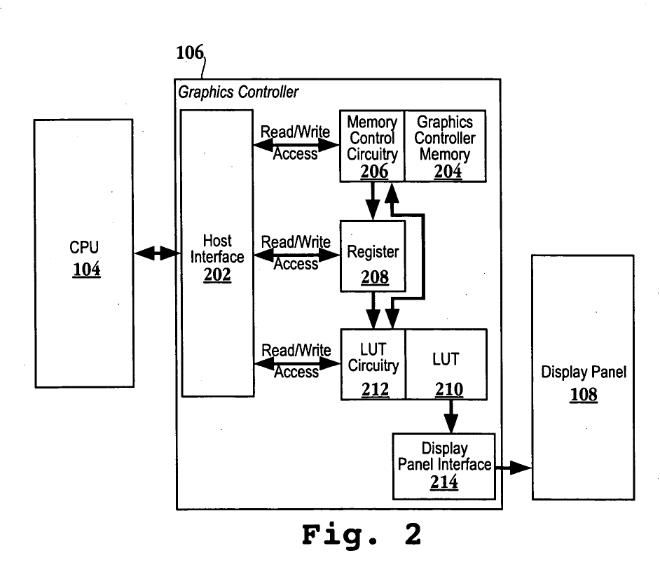

FIG. 2 is a detailed schematic diagram of the graphics controller shown in FIG. 1, in accordance with one embodiment of the present invention. As shown in FIG. 2, graphics controller 106 includes host interface 202, graphics controller memory 204, look-up table (LUT) 210, display panel interface (I/F) 214, and register 208. Host interface 202, which is in communication with CPU 104, has read and write access to graphics controller memory 204, LUT 210, and register 208. Display panel interface 214 interfaces with display panel 108. Accordingly, image data and corresponding display control signals are communicated between display panel interface 214 and display panel 108.

Included with graphics controller memory 204 and LUT 210 are memory control circuitry 206 and LUT circuitry 212, respectively. It should be appreciated that memory control circuitry 206 includes circuits (e.g., decoders, row select drivers, sense amplifiers, etc.) that enable data to be read from and written to graphics controller memory 204. Furthermore, graphics controller memory 204 includes a frame buffer that is a portion of the graphics controller memory reserved for holding a complete bit-mapped image that is sent to display panel 108 for display. Similarly, LUT circuitry 212 includes circuits that enable data to be read from and written to LUT 210 and, as will be explained in more detail below, for adjusting colors of an image. For example, in one embodiment, LUT circuitry 212 includes circuitry for copying LUT values stored in LUT 210 to graphics controller memory 204 and circuitry for modifying the LUT values stored in the LUT to change the colors of the image.

Pixel data is fetched from graphics controller memory 204 and the pixel data is translated to the appropriate color through LUT 210. It will be apparent to one skilled in the art that that LUT 210 is a table of cross-references that links pixel values to output red, green, and blue color component values. LUT 210 is used to quickly determine the colors and intensity values with which a particular image will be displayed. The translated color component values from LUT 210 are then directed to display panel 108 through display panel interface 214. FIG. 2 shows LUT 210 is a separate piece of memory, i.e., another memory instance, that acts as a translation table. However, graphics controller memory 204 and LUT 210 may also share the same memory. It should be appreciated that graphics controller memory 204, LUT 210, and display panel interface 214 may be configured as a pipeline operation for each pixel to be displayed on display panel 108.

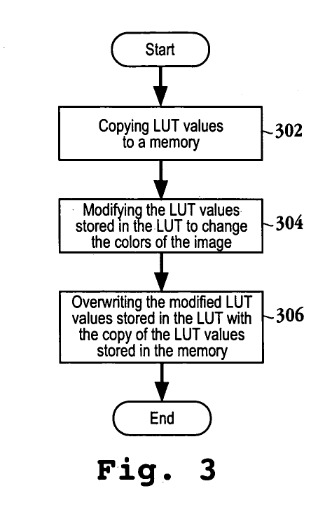

FIG. 3 is a flowchart diagram of a high level method overview for adjusting colors of an image, in accordance with one embodiment of the present invention. As shown in FIG. 3, starting in operation 302, LUT values stored in the LUT are copied to a memory to create a copy of the LUT values. After the LUT values are copied, the LUT values stored in the LUT are modified in operation 304 to change the colors of the image. That is, the modification of the LUT values stored in the LUT changes the colors with which the particular image will be displayed. Accordingly, the colors of the image with the modified LUT values are different from the original colors of the image. As shown in operation 306, after the colors are changed, the original colors of the image may be restored by overwriting the LUT values stored in the LUT that were modified with the copy of the original LUT values stored in memory.

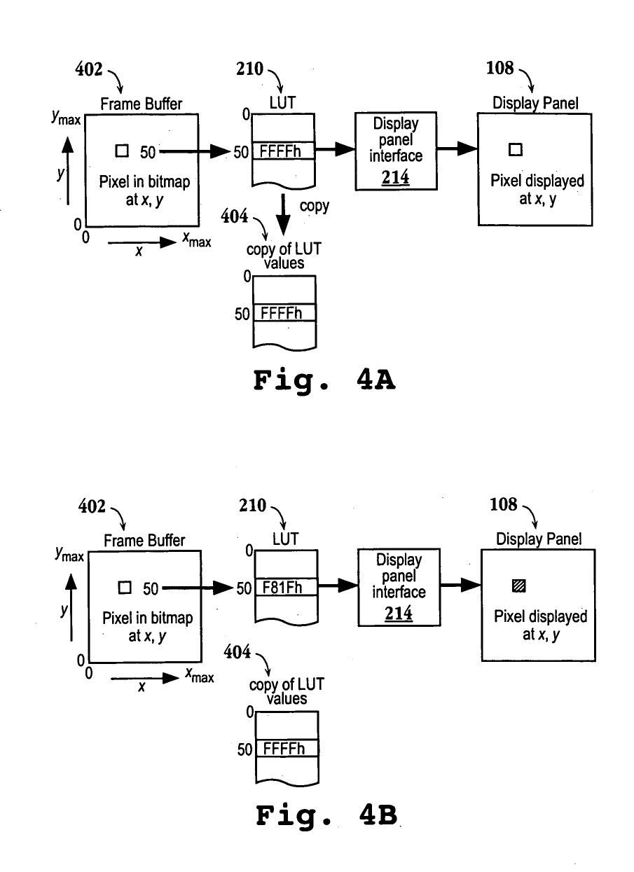

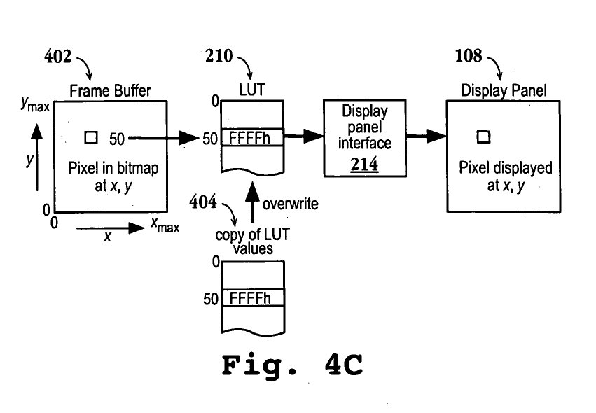

FIGS. 4A-4C are simplified block diagrams of exemplary operations for adjusting the colors of an image, in accordance with one embodiment of the present invention. FIGS. 4A-4C include frame buffer 402, LUT 210, display panel interface 214, and display panel 108. As discussed above, frame buffer 402 is a portion of the graphics controller memory reserved for holding a complete bit-mapped image that is sent to display panel 108 for display. As shown in FIG. 4A, frame buffer 402 stores the pixel values of the image. It should be appreciated that a pixel of an image can be represented in frame buffer 402 by a number of bits. Each stored pixel value specifies a color output of a pixel by display panel 108. For example, each pixel of an image can have as high as eight bits to give shades of gray perceived as continuous from black to white. Thus, a gray-scale display panel often requires eight bits/pixel, giving 256 different shades. A true color display can have eight bits/pixel for each color channel, giving a total of twenty four bits/pixel and about sixteen million displayable colors.

Many graphic controllers have limited bits per pixel and use LUT 210 to convert each of these pixel values to a set of three primary output color values. In particular, LUT 210 is a table of cross-references linking pixel values to output values, and can be used to determine the colors and intensity values with which a particular image will be displayed. To accomplish this, the pixel value is used as an index into LUT 210 to obtain an entry which holds output values for the intensity of each primary (red, green, blue) color. As shown in FIG. 4A, a pixel in a bitmap image at location x, y that is stored in frame buffer 402 has a pixel value of fifty. The pixel value of fifty corresponds to an index value of fifty in LUT 210, and an RGB565 hexadecimal FFFF output value is linked to the index value of fifty. The FFFF output value specifies the intensity of each primary color, and one skilled in the art will appreciate that the 565 in RGB565 represents the number of bits used to store each color component. Here, the red and blue components are stored with five bits and the green component is stored with six bits. Display panel interface 214 receives the outputted value of FFFF from LUT 210, and outputs the pixel for display at location x, y on display panel 108.

Still referring to FIG. 4A, to adjust the colors of the image, the LUT values stored in LUT 210 are first copied to a memory to create a copy of the LUT values. Thus, one copy of the LUT values is stored in LUT 210, and a second copy 404 is stored in the memory. In one embodiment, copy of LUT values 404 can be stored in a graphics controller memory or, in another embodiment, the copy of LUT values may be stored in an unused memory block of LUT 210. After copy of LUT values 404 has been made, the LUT values stored in LUT 210 may be modified to change the colors of the image. For example, as shown in FIG. 4B, output value of FFFF, an LUT value, is modified to F81F. As such, index and pixel value of fifty correspond to an output value of F81F instead of FFFF. Output value of FFFF results in a white color while F81F results in a purple color. Accordingly, the modification of the LUT value changes the white colored pixel displayed at location x, y on display panel 108 to a purple colored pixel. It should be appreciated that any suitable LUT values can be modified. Each output value can be comprised of three color component values and, in one embodiment, one or more of the color component values may be modified. For example, the output values can be modified to eliminate the green color component, without modifying the red and blue components, to allow an image to be viewed without the green color component to provide a color haze effect. In another example, the image can be blanked by modifying all output values to high or low values which results in an all white or black image, respectively.

To restore the original colors of the image, the modified LUT values stored in LUT 210 is overwritten with copy of LUT values 404 stored in the memory. As a result, as shown in FIG. 4C, the modified F81F output value linked with index fifty and stored in LUT 210 are overwritten with the original FFFF output value from copy of LUT values 404. Thus, the pixel and index value of fifty again correspond with the original FFFF output value, and the overwrite restores the purple colored pixel displayed at location x, y on display panel 108 to a white colored pixel.

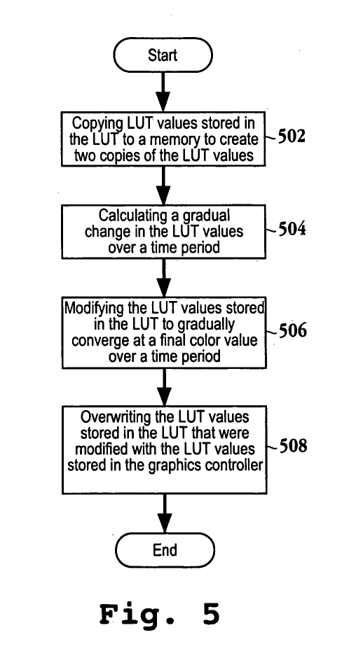

FIG. 5 is a flowchart diagram of a method for adjusting colors of an image such that the colors fade or brighten over a time period, in accordance with one embodiment of the present invention. In one embodiment, a fading or brightening function using the LUT can be implemented by modifying the colors of the image such that the colors gradually dim or brighten, respectively, over a period of time. Specifically, as shown in FIG. 5, LUT values stored in the LUT are first copied to a memory in operation 502 to create two copies of the LUT values. The first copy of the LUT values is stored in the LUT and the second copy of the LUT values is stored in the memory.

Thereafter, in operation 504, a gradual change for each of the LUT values over a time period is calculated. The gradual change of the colors results in a fading or brightening effect. The gradual change is based on the output value, the time period, and a final color value. In one exemplary embodiment, gradual change of a pixel is defined by:

$$Gradual\_change = \frac{output\_value - final\_color \_value}{time\_period} \qquad ( 1.0 )$$

With reference to equation 1.0, the color of pixel is faded or brightened to the final color value. The final color value is the final color that comes at the end of the convergence. For example, if the final color value is black, then the color of the pixel is instantaneously changed to black or gradually faded to black. The final color value is provided to the graphics controller, and in one embodiment, is stored in a register of the graphics controller (e.g., register 208 of FIG. 2). The time period is an interval of time from which the original color of the image is changed to the final color value, and the time period is also provided to the graphics controller and can be stored in a register of the graphics controller (e.g., register 208 of FIG. 2). As discussed above, the output value is an LUT value stored in the LUT that specifies the intensity of each primary (red, green, blue) color to a color display panel. Consequently, the gradual change is an incremental color value if the pixel is brightened, and the gradual change is a decremental color value if the pixel is faded.

Still referring to FIG. 5, after the gradual change is calculated, the LUT values stored in the LUT are modified in operation 506 to gradually converge at the final color value over the time period. That is, the LUT values stored in the LUT are modified by the calculated, gradual change. For example, to gradually fade the colors of an image, the LUT values stored in the LUT are decreased gradually to converge at the final color value over a time period. In other words, the calculated, decremental value is subtracted from each of the LUT values stored in the LUT until the LUT values converge at the final color value. Conversely, to gradually brighten the colors of an image, the LUT values stored in the LUT are increased gradually to converge at a final color value over a time period. That is, the calculated, incremental color value is added to each of the LUT values stored in the LUT until the LUT values converge at the final color value. Finally, as shown in operation 508, the original colors of the image may be restored by overwriting the modified, LUT values stored in the LUT with the copy of the original LUT values stored in the memory.

In summary, the above described invention provides hardware implemented method, graphics controller, and LUT for adjusting colors of an image. By providing the ability to change the colors of an image by modifying the LUT values, the graphics controller is not limited to providing a blanking effect, but can also provide the capability to gradually fade or brighten an image. Furthermore, fading or brightening an image requires minimal CPU bandwidth because such fading or brightening calculations are offloaded from the CPU to the graphics controller.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

1. A hardware implemented method for adjusting colors of an image, comprising method operations of:
copying lookup table (LUT) values stored in an LUT to a memory to create a copy of the LUT values, the LUT values defining original colors of the image;
modifying the LUT values stored in the LUT to change the colors of the image; and
overwriting the LUT values stored in the LUT that were modified with the copy of the LUT values stored in the memory to restore the image to the original colors.

2. The hardware implemented method of claim 1, further comprising:
calculating a gradual change in the LUT values over a time period.

3. The hardware implemented method of claim 2, wherein the LUT values stored in the LUT are modified by the calculated gradual change.

4. The hardware implemented method of claim 1, wherein the method operation of modifying the LUT values stored in the LUT includes,
modifying the LUT values stored in the LUT to converge at a final color value over a time period.

5. The hardware implemented method of claim 1, wherein the method operation of modifying the LUT values stored in the LUT includes,
increasing gradually the LUT values stored in the LUT to converge at a final color value over a time period.

6. The hardware implemented method of claim 1, wherein the method operation of modifying the LUT values stored in the LUT includes,
decreasing gradually the LUT values stored in the LUT to converge at a final color value over a time period.

7. The hardware implemented method of claim 1, wherein at least one color component of the LUT values stored in the LUT is modified, each of the LUT values being defined by three color component values.

8. The hardware implemented method of claim 1, wherein the memory is a graphics controller memory.

9. A lookup table (LUT) for adjusting colors of an image, comprising:
circuitry for copying lookup table (LUT) values stored in the LUT to a memory to create two copies of the LUT values, a first copy of the LUT values being stored in the LUT and a second copy of the LUT values being stored in the memory, the LUT values defining original colors of the image;
circuitry for modifying the LUT values stored in the LUT to change the colors of the image; and
circuitry for overwriting the LUT values stored in the LUT that were modified with the LUT values stored in the memory to restore the image to the original colors.

10. The LUT of claim 9, further comprising:
circuitry for calculating a gradual change in the LUT values over a time period.

11. The LUT of claim 9, wherein the circuitry for modifying the LUT values stored in the LUT includes,
circuitry for modifying the LUT values stored in the LUT to converge at a final color value over a time period.

12. The LUT of claim 9, further comprising:
circuitry for calculating an incremental color value.

13. The LUT of claim 12, wherein the circuitry for modifying the LUT values stored in the LUT includes,
circuitry for adding the incremental color value to each of the LUT values stored in the LUT to gradually converge at a final color value over a time period.

14. The LUT of claim 9, further comprising:
circuitry for calculating a decremental color value.

15. The LUT of claim 14, wherein the circuitry for modifying the LUT values stored in the LUT includes,
circuitry for subtracting the decremental color value from each of the LUT values stored in the LUT to gradually converge at a final color value over a time period.

16. The LUT of claim 9, wherein the memory is an unused memory block of the LUT.

17. A graphics controller for adjusting colors of an image, comprising:
a host interface;
a graphics controller memory in communication with the host interface; and
a lookup table (LUT) in communication with the host interface and the graphics controller memory, the LUT including,
circuitry for copying LUT values stored in the LUT to the graphics controller memory to create two copies of the LUT values, a first copy of the LUT values being stored in the LUT and a second copy of the LUT values being stored in the graphics controller memory, the LUT values defining original colors of the image,
circuitry for modifying the LUT values stored in the LUT to gradually converge at a final color value over a time period, and
circuitry for overwriting the LUT values stored in the LUT that were modified with the LUT values stored in the graphics controller memory to restore the image to the original colors.

18. The graphics controller of claim 17, further comprising:
a display panel interface in communication with the LUT, the display panel interface being configured to output the image for display.

19. The graphics controller of claim 17, further comprising:
a register in communication with the LUT and the host interface, the register being configured to store the final color value.

20. The graphics controller of claim 17, wherein the graphics controller is incorporated into a portable electronic computing device.
